(19) United States
(12) Patent Application Publication
(10) Pub. No.: US 2011/0243707 A1
(43) Pub. Date: Oct. 6, 2011

(54) METHOD AND EQUIPMENT FOR DISPENSING PRODUCTS FOR PACKAGING SAME

(75) Inventors: Emmanuel Dumas, Villefranche de Rouergue (FR); Thierry De Lazzari, L'Honor de Cos (FR)

(73) Assignee: DE LA BALLINA FRERES, Maleville (FR)

(21) Appl. No.: 13/139,423

(22) PCT Filed: Dec. 10, 2009
(86) PCT No.: PCT/IB2009/007722

§ 371 Date: Jun. 13, 2011

(30) Foreign Application Priority Data
Dec. 11, 2008 (FR) 08/06956

(51) Int. Cl. G05B 19/418; G06F 7/00; B65H 1/00

(52) U.S. Cl. 414/806; 700/224; 700/259

(57) ABSTRACT

The invention related to dispensing discrete products at the end of a production line to be placed loosely or in an orderly manner into packaging containers. The dispensing line according to the invention comprises a means for alternately controlling, particularly on the basis of location information gathered in a visiometric checkpoint through which the products are caused to pass, the routing of products to be placed loosely into packaging containers to a comb sort where they are regrouped by lot, or the individual inputting of products to be placed into packaging containers in an orderly manner by robotic grasping and transferring means.

The present invention relates to the packaging of discrete products, and more particularly it relates to their distribution at the end of an industrial production line for wrapping and packaging them by lots (i.e.; batches) for delivery to clients. The invention is preferably applicable in the industrial bakery sector, including pastries, and it will be more specially described in this document in its application to this industrial field.

One of the issues specific to this sector is related to the variety of shapes of the manufactured products, whether it involves oblong products such as baguettes, or whether it involves products with varied sizes and more homogenous individual dimensions such as pastries, or bread balls or slabs.

In connection with this variety of shapes, the delivery conditions of the finished products are highly variable. As a non-limiting example, it may be desirable for small products to be placed in bulk in suitable packaging receptacles (most often boxes, but possibly baskets or cartridges, or any other suitable type of container), and for other products, for example baguettes or bread balls, it may be preferable to arrange them in ordered places in the containers receiving them.

The present invention aims at optimizing the volume occupied by the products in the packaging containers, irrespective of the shapes and dimensions of those products, and whether these products are to be placed in bulk or arranged by rows in said containers. The invention thus aims at improving the profitability of the equipment while increasing its operating flexibility and respecting the good quality of the products to be delivered.

To that end, the invention relates to an equipment for dispensing discrete products at the end of an industrial production line, which in a non-limiting example may be at the outlet of a furnace or of a deep freezer when dealing with industrial bakery products. It provides for such an equipment in which the products are made to pass through a visiometric examination system that determines the conditions for their distribution for packaging. Examination of the products is performed so as to provide in particular, for each of the products, at least a location information. This information is generally processed automatically, in a known manner, in different combinations with quality and/or counting information also determined from the images acquired by visiometry.

According to one feature of the invention, this equipment includes a means for alternatively controlling either, on the one hand, the routing of products intended to be placed in bulk in a packaging container through a sorting combing device where they are grouped together by lot or, on the other hand, the individual inputting of products to be placed into packaging containers in an ordered manner by robotic means via which they are transferred off the main production line of the products leading to the sorting comb.

Advantageously and in a manner known per se, the sorting comb is commanded as a function of the location and counting information provided by the visiometry examination station, so as to temporarily suspend, if necessary, the advancement of certain products while allowing the advancement of certain other products, so as to form, downstream of said sorting comb, lots (or batches) of predefined amounts of the products.

More precisely, the equipment according to the invention includes a belt using which the products are made to advance successively through a visiometric examination device, or visiometry station, then in front of individual robots for individual product grasping and transfer means disposed laterally along said belt, and lastly towards a sorting comb. According to different embodiments of the invention, the robots can be arranged on either side of the production belt, or all be distributed on the same side of this belt. It should also be noted that the production belt can indifferently, without harming the implementation conditions of the invention, be made up of one or more strips successively arranged longitudinally, combined with one or more motors to drive them and make the products advance.

The invention provides that the products intended to be placed in bulk into the packaging containers receiving them be conveyed to the sorting comb, where they will be grouped together by lots before falling unordered into said containers, and the products intended to be arranged in an ordered manner in the packaging containers are grasped by robot means commanded to transfer them laterally off the main line leading to the end comb and lay them down individually in these containers.

According to one preferred embodiment of the invention, each of the robots being part of the robotized means includes means for validating the reality of the grasping of the product(s) in compliance with the instructions automatically transmitted to it as a function of the information collected by visiometry. The general control system of the equipment is programmed to use the validation information in connection with counting the products transferred so that each receptacle be filled with a cumulative number of products corresponding to a predefined quantity. This definition refers to a method of grouping the products by lots that is very different from the one used at the sorting comb for bulk products.

According to one particular embodiment of the invention, the means for validating the grasping operate by checking the weight of the objects transported by each robot. Knowing the unitary weight of the products, it is possible to deduce, from the overall weight of the transported products, the number of products effectively grasped. It is here necessary to understand that the notion of individual grasping of the products is still respected even when a same robot is used to grasp several products in a same operation, as is the case, for example, for robots with grasping members with multiple vacuum suckers. Checking the number of products transferred by the robots is then particularly interesting. Further, checking the weight at the robotized grasping and transfer means allows for a possible discrimination process whereby at the time of grasping, products alongside or very close to one another on the production line will be handled separately, which will be useful in particular when small products are involved.

According to other advantageous embodiments of the invention, a similar validation of the conditions for grasping products by the robotic means can be done by proceeding with a secondary visiometric examination process on the products during their transfer by the robot means. To that end it is in particular possible to provide one or more cameras placed between the main transport belt and the packaging container, so that the field of vision of each camera be directed towards the lower face of the products grasped by one of the individual grasping robots at the place where they are being transferred laterally out of the main transport line. The invention then provides for each camera to be controlled automatically, inasmuch as the corresponding robotic grasping means has grasped one more products, to acquire images of the lower surface of those products, and associated automatic processing means are operated so as to deduce from the acquired images an information indicating the presence, location, and/or count of the grasped products. This information can be used to automatically control the relative movement of each robot means in relation to the packaging containers and the release of the grasped products at the right time in the right place.

It should be noted that, when arrangement of the products in the packaging containers demands it, the location information collected at the visiometry examination station advantageously includes information relative to the morphology and orientation of the products, from which information the robots are then controlled to move so as to grasp, then organize the products in the desired manner in the packaging containers. The equipment according to the invention thereby makes it possible, as non-limiting examples, to place in the packaging containers products arranged crosswise or in stacks, products arranged vertically or on edge, products placed head to tail relative to each other, etc.

As described above, the robot lateral grasping and transfer means are placed upstream of the sorting comb in the direction of transport by the belt on which the products are conveyed. The products they seize are therefore removed before they can reach said sorting comb. In specific situations, the latter may be controlled temporarily so as not to withhold any of the products that are routed to it and thus to allow all of said products to pass through. According to one advantageous embodiment of the invention, the sorting comb can also be controlled so as to form lots with the products that have not been extracted by the robot means. In this case, the two distribution methods are combined, which imparts an additional advantage to the invention, when for example one wishes to package a same product in lots with different quantities for a customer or several customers.

The invention makes it possible to have two separate methods of distributing the products, each one being specifically adapted to a packaging mode (product delivered in bulk or products arranged in order in respective packaging containers), and wherein in particular the operation is controlled from location information provided while the products are conveyed through a shared visiometric station and not depending from the later packaging form of said products. It should, however, also be noted that it is possible to combine the two operating modes simultaneously. This can be useful to distribute products admitted into the equipment by separating them into several categories, some of the products being taken and distributed by the robots, others undergoing another sort at the end comb.

The invention thus achieves one of its aims by increasing the operating flexibility of the equipment.

Furthermore, by specifically dedicating one or the other of the distribution means (i.e. the sorting comb or individual extracting robot means) to one or the other of the chosen packaging methods (products placed in bulk or products placed in an ordered manner), the invention achieves another of its aims, which relates to optimizing the volume occupied by the products in the packaging containers. This optimization is also achieved via a single production line, which therefore does not require much space and is versatile, therefore representing a limited investment. Furthermore, by optimizing the volume occupied by the products in the packaging containers, the invention also leads to a decrease in discards that may result from products being damaged due to poor placement thereof in the containers. The invention therefore also leads to improved profitability for the production equipment in its entirety.

Another advantage of the invention is that, by optimizing the volumes occupied by the products in the packaging containers, it contributes to reducing transport, handling, and logistics costs, as well as the costs associated with the containers themselves (raw materials, etc.).

According to another feature of the invention in its preferred embodiments, the distribution of the products separated between the robots and the sorting comb is applied following a quality control process conducted from quality information data, e.g. relative to size, shape, and/or color, which are supplied by the visiometry station. The latter then includes means to compare this information to a set of predetermined criteria and to deduce a quality attribute therefrom (in the form of compliance or non-compliance with the predetermined criteria) that is allocated to each of the products made to pass through the visiometry station.

According to one of its features in this preferred embodiment, the is invention provides that, when the products made to progress are intended to be placed in bulk into packaging containers, those of said products that were deemed not to comply with the predetermined quality criteria are individually grasped by the robot grasping and transferring means to be removed from the production line on which the sorting comb is placed, towards which said products are routed that have been designated in compliance with the predetermined quality criteria.

Concomitantly, the invention provides that, when the products made to progress are intended to be placed in an ordered manner by lateral transfer into packaging containers, those of the products deemed to comply with the predetermined quality criteria are individually grasped and removed by the robot means while those deemed not to comply with said criteria are conveyed towards the sorting comb, which is then ordered to allow all of the products arriving at that point to pass freely towards a specific reject zone.

According to another feature of the invention, the validation of the grasping of the products at the robot lateral grasping and transfer means is an additional step making it possible to ensure they are placed in a predetermined number in each container intended to receive them. This validation is advantageously done via a visiometric examination process performed during the lateral transfer of the products using the different robot means.

According to one particularly advantageous alternative embodiment of the invention, it is thus provided to associate each robot means with one or more visiometry cameras arranged on the robot's path outside the belt of the main production line of the products and oriented to observe, from below, the products grasped during their transfer towards the container provided to receive them. In addition or alternatively to checking the presence of the products whereof grasping has been ordered, the invention advantageously makes it possible for the processing means associated with each of these cameras to be ordered to deduce, from the images captured by said cameras, information for example relative to the color, appearance (stains, etc.), and/or texture of the lower surfaces of the products to perform an additional quality control step by comparing this information to a set of predefined additional criteria. By combining the results of this additional quality control and the location information provided by the visiometry station, the robots can then be controlled automatically, according to another feature of the invention, on the one hand to deposit those of the products whereof the quality has been deemed satisfactory after the additional quality control in a packaging container, and on the other hand to route those products whereof the quality, although proved satisfactory after their passage in the main visiometric station on the top side, were proved insufficient after the additional quality control done on their lower surface, towards a rejection zone.

According to another additional feature of the embodiment of the invention, the equipment is programmed to ensure the rejection of all products examined during a given time period when the percentage of products designated non-compliant with the predefined quality criteria exceeds a predetermined threshold. The excess of this threshold is detected at the visiometric station and the sorting comb is then automatically ordered to allow all products to pass towards the suitable rejection means, for example by routing them towards a specific conveyor belt.

The arrangement of the robotic means for laterally extracting products along the main line leading to the end comb lends itself particularly well to operation at an optimal rhythm regardless of the type of products to be processed. For example, a same number of robots can easily be adapted to alternately either ensure the individual grasping of products that are found compliant when handling relatively bulky products that are traveling in limited instantaneous number towards the comb, the latter then serving to eject non-compliant products, or to ensure individual removal of products found not quality compliant when handling products that are to traveling at a relatively fast pace in instantaneous quantity and are delivered in bulk through the sorting comb, in which case typically the latter serves to group together the compliant products in lots of predetermined quantities.

The invention generally alternatively makes it possible to perform, as on a same line, either the distribution of products to be delivered in bulk packed at the end of a main transport line, or the distribution of products to be placed laterally in appropriate containers relative to said main line, while combining this distribution with a quality control of the products and/or their counting for distribution by lots.

In combination with the quality control, it may be advantageous, depending on the practical implementation conditions of the invention, to simultaneously apply both packaging modes (deposition in bulk at the end of the line and individual transfer into laterally arranged containers), for example to produce lots of different quantities of a same product while sorting the compliant products according to a count.

Substantial gains relative to processing costs and the bulk of the equipment can be obtained by using the same robotic grasping and transfer means in the different operating modes so as, when the products are to be in bulk placed in a packaging container, to remove products not in compliance with the predetermined quality criteria from the production line during the visiometric examination stop or, when the products are to be arranged in an ordered manner in containers conveyed laterally relative to the main line, to individually grasp the products proved to be in compliance with said criteria to place them in said containers, or to individually grasp products to place some in a lateral packaging container and others in a rejection zone.

Other features and advantages of the invention will appear from the detailed description of one of its preferred embodiments illustrated by the following figures:

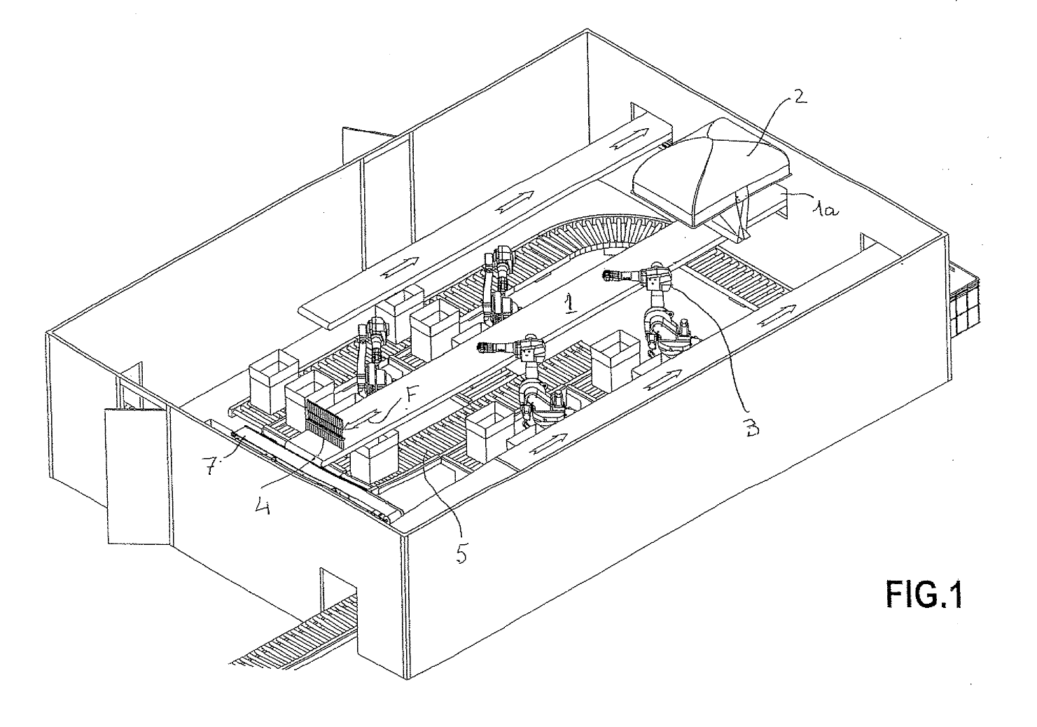

FIG. 1, which shows a diagrammatic perspective view of equipment according to the invention, in an industrial bakery plant,

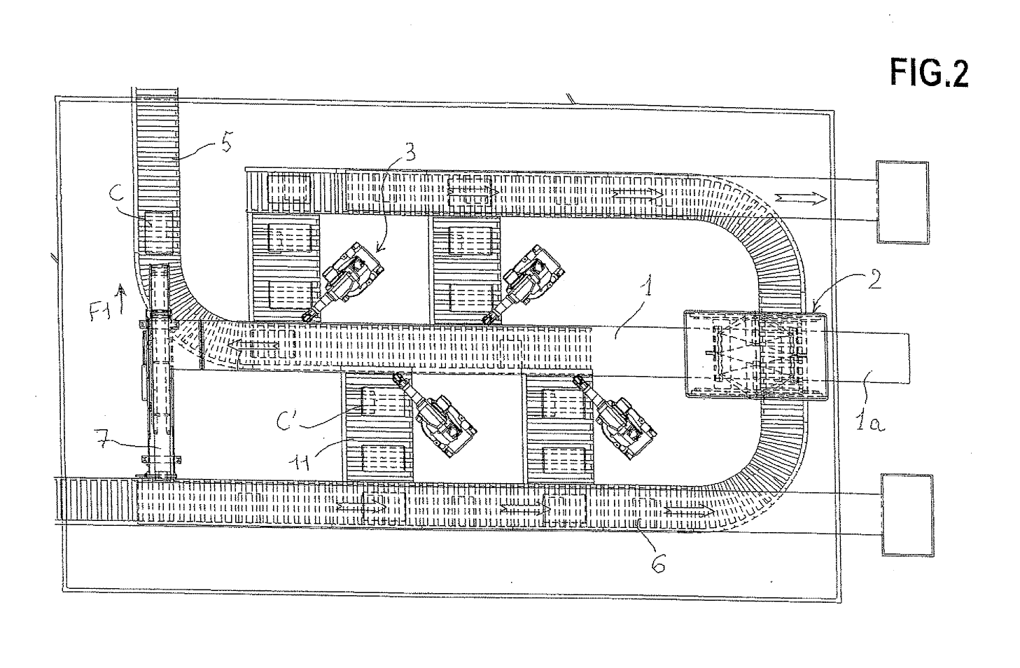

FIG. 2, which shows a top view of the equipment,

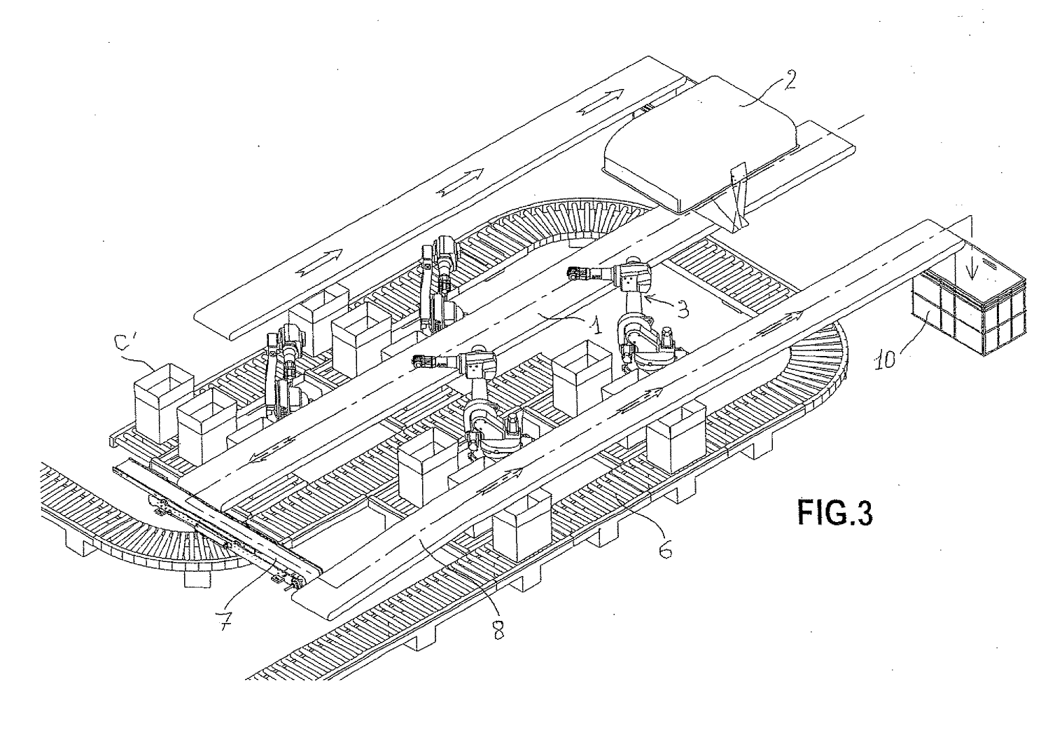

FIG. 3, which illustrates the operation of the equipment according to the invention for packaging products to be placed individually in packaging boxes in an ordered manner,

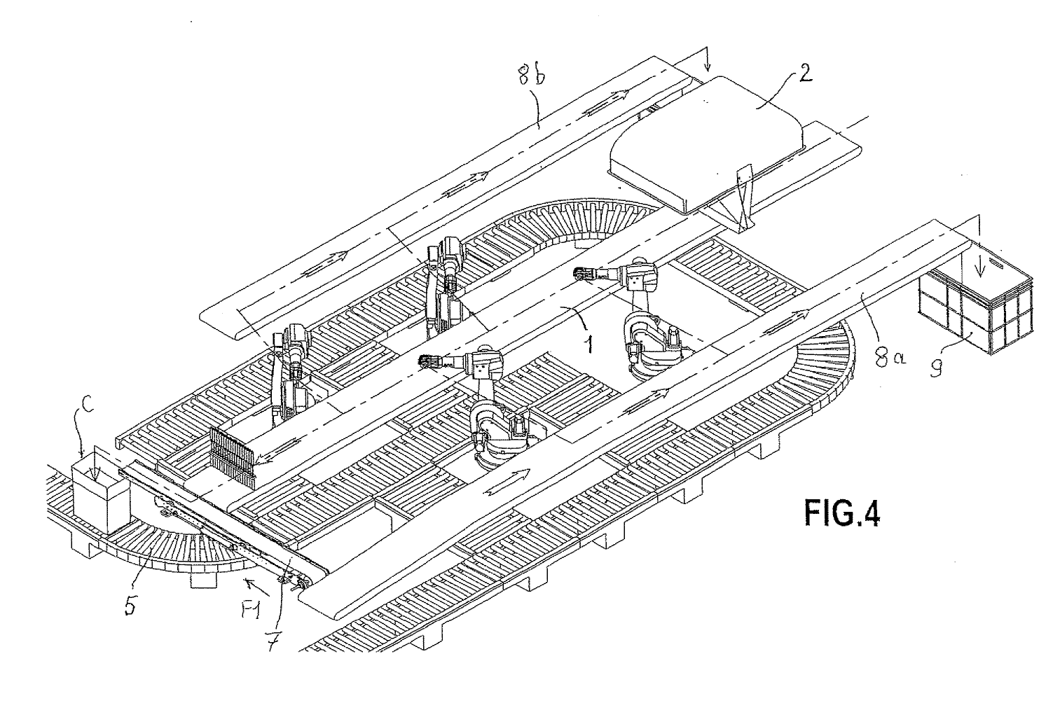

FIG. 4, which illustrates the operation of the equipment according to the invention for packaging products to be delivered in bulk in packaging boxes.

The equipment according to the invention includes a main conveyor belt 1 on which the products to be packaged are made to pass. These products typically reach zone la of the belt 1 in lots of predefined quantities defined by the prior production step from which they have come (pre-baking, baking, etc.). They can arrive in a steady stream or sequentially, but are typically randomly arranged and oriented on the input belt 1, even if they can, for example when involving long products, arrive with a preferred general orientation. The direction of travel of the belt 1 is diagrammed by an arrow, from right to left in the figures.

Upon arriving on the belt, the products then pass through a visiometry station 2 where information is collected in particular relative to their location, relative positions, respective morphologies (substantially isotropic products, such as bread balls, or anisotropic, such as baguettes), and potentially the orientation for anisotropic products.

According to the preferred embodiment of the invention shown in the figures, quality information relative to the dimensions (length, width, height), color, appearance (cooking, scarification) and/or shape of the products is also collected in the visiometry station 2. This information is then processed automatically to be compared to a set of predetermined criteria and to deduce therefrom, for each of the products passing through the visiometry station 2, a quality attribute in the form of compliance or non-compliance with the aforementioned predetermined criteria.

The equipment according to the invention also has, successively to in the direction of movement of the belt 1, a set of robotic means 3 distributed on either side of said belt, as well as a sorting comb 4 placed at the downstream end of the belt 1, at the end of the main routing line of the products, after the robotic means 3.

The robotic means 3 can non-limitingly be robotic means with claw, vacuum suckers, or needle graspers.

The comb 4 is a normal sorting comb in the field. It is made up of teeth or fingers placed crosswise, substantially perpendicular to the plane of the belt, therefore vertically, across the path of the products driven with the belt, and which are tiltingly mounted around their horizontal upper axis, separately from each other. The control of the various tilting teeth of the comb is programmed automatically, from the location information collected in the visiometry station 2 and counting information developed by the steering system of the equipment, to allow, at each moment, certain products to pass while retaining certain others temporarily, so as to group the products together in lots downstream of said comb.

According to one preferred embodiment of the invention, the counting information used to control the sorting comb 4 is in particular deduced from location information and height information of the objects that pass through the visiometry station 2.

The described equipment includes a first packaging box conveyor 5, which passes under the belt 1 to present one such box at the end of the belt, beyond the sorting comb 4. It also has a second box conveyer 6, the circuit of which passes near the different robots 3 situated on either side of the production belt 1, so that each of said robots can extract products from the production belt and transfer them laterally to place them in a box located nearby. The boxes collecting loose products circulate on the first box conveyer 5, as illustrated by the box C in FIG. 4, whereas the boxes collecting orderly products circulate on the second box conveyer, as illustrated in FIG. 4 for boxes C′ during filling.

When the products traveling on the belt 1 are to be delivered loosely, by lots of predefined quantities, in boxes C that travel on the first box conveyer 5 (see FIG. 4), the sorting comb 4 is commanded from information collected in the visiometry station 2, i.e. from location information, counting information, and quality attributes that have been assigned to each of the products, to group together predefined quantities of these products by lots whereof the quality, during their passage through the visiometry station 2, has been deemed to comply with the predetermined quality criteria. Once this grouping is done at the sorting comb, the lots of predefined quantities of products are conveyed towards a box C circulating on the first box conveyer 5.

More specifically, in the embodiment illustrated by FIG. 3, after their passage through the sorting comb 4, the products are poured onto a transverse conveyor belt 7 controlled to move in a first direction, the direction shown by arrow F1 in FIG. 3, to pour them into a box C during filling present on the first conveyer 5. A hopper, not shown in the figures, is advantageously inserted between the end of the conveyor belt 7 and the box conveyer 5 in order, on the one hand, to slow the fall of the products in the box C and limit its effects (risk of product breakage in particular), and on the other hand, to promote the organization of the products in said box.

At the same time, the robots 3 are commanded, from location information and quality attributes assigned to each of the products, to individually remove from the production belt 1, before passage in the sorting comb 4, those products that were, during their passage in the visiometry station 2, assigned an attribute of non-compliance with the predetermined quality criteria. These products are then transferred by the robots 3 on one of the lateral reject belts arranged parallel to the production belt 1, which are illustrated in 8a and 8b in FIG. 4. These belts are controlled, as illustrated by the arrows in FIG. 4, to convey these products toward the reject tubs 9.

If, however, the percentage of products proved non-compliant with the predefined quality criteria (in density on the surface of the belt) reaches a previously determined threshold, the sorting comb is commanded from this information provided by the visiometry station to allow all of the products to go to there. The conveyor belt 7 is then ordered to move backwards, in the direction opposite that indicated by the normal operating arrow F1 in FIG. 4 (second direction relative to the first direction illustrated by arrow F1) to convey these products towards the reject belt 8a and, from there, towards the corresponding reject tub 9.

When the products passing on the belt 1 are to be placed in an ordered manner by lots of predefined quantities in the boxes C′ that circulate on the second box conveyer 6 (see FIG. 3), the grasping robots 3 are automatically commanded, from location information and counting information collected in the visiometry station 2, as well as from quality attributes assigned to each of the products, to remove those products whereof the quality, during their passage through the visiometry station 2, was proved compliant with the predetermined criteria. Each of the robots 3 is then automatically controlled, in particular from information relative to the morphology and orientation of the products, to transfer said products towards the box C′ in its immediate vicinity and organizes them according to a predefined mode (storage in stacks, head to tail, etc.).

Other operating modes of the equipment as described here can be implemented, for example if the products circulating on the belt 1 and coming from a same production can be packaged by lots of different quantities. According to one alternative used as an example, all of the robotic means 3 are commanded so as, aside from the products assigned a non-compliance attributed for their passage in the visiometry station 2, to grasp certain products that have been assigned a compliance attribute and organize the latter in boxes C′ while the former (non-compliant) will be routed towards a reject belt. In particular, some of the robotic means can be assigned to grasp only products proved non-compliant while other robotic means will be reserved to grasp only products proved compliant to place them individually in a box C′.

Another alternative embodiment is shown in FIG. 2. This figure shows that each robotic means is capable of reaching two different boxes C′, which are simultaneously brought into the vicinity thereof by a secondary conveyor 11, and of placing the products it transports in one or the other, depending on the orders it receives from the general steering in system.

According to one particularity of the invention in the equipment described as an example, it is associated with each of the robots 3 of the means for validating the grasping of the transported objects. These means were not detailed in the figures. They are known in themselves, inasmuch as they were described in particular in a prior patent by the applicant company. They are embodied by a second visiometry system examining the products from the bottom, comprising cameras whereof the field of vision is oriented towards the lower surface of the products during the transfer between the belt 1 and each of the robots 3. Associated with each camera thus ordered to capture images of the lower face of the grasped products are image processing means that deduce information from the acquired images relative to the location of the grasped products, as well as their shape, color, texture, etc.

These automatic processing means then produce, from the location information, a validation of the number of grasped products. They also compare the information relative to the shape, color, texture, etc. of the lower surface of the grasped products with a set of predefined additional quality criteria to deduce an additional quality attribute therefrom allocated to each of the grasped products. Each of the robots 3 is then automatically commanded so as, on the one hand, to place and organize in a box C′ located near it, those products that were assigned an attribute of compliance with the additional quality criteria, and so as, on the other hand, to place, on one of the reject belts, those products that were assigned an attribute of non-compliance with these same additional quality criteria.

At the same time, those products that were assigned, during their passage through the visiometry station, an attribute of non-compliance with the predetermined criteria are directly conveyed towards a reject zone. According to the embodiment more specifically illustrated in FIG. 3, these products are routed towards the sorting comb 4, which is then ordered not to retain any of the products passing through it, then towards the transverse conveyor belt 7 and towards one of the reject belts 8, which discharges them towards a reject tub 10, e.g. placed at the end of this reject belt.

According to other embodiments of the invention, these products can be routed towards one or more specific reject zones, without passing through the sorting comb 4.

The invention thus produces a versatile packaging line that can be used indifferently to package lots of predefined quantities of products placed in bulk or arranged in an ordered manner in boxes. It therefore allows greater adaptation to the varied needs of the industry, in particular the needs of the bakery industry in the context of which it was described.

Using the same robotic grasping means so as, on the one hand, when the products are to be packaged loosely, to remove those products from the packaging line that are proved non-compliant with the predefined quality criteria, and, on the other hand, when the products must be stored individually in an ordered manner in their packaging containers, to grasp products deemed compliant with these quality criteria, this equipment also represents a reduced investment cost.

Furthermore, by allowing the choice on the same line, for a given production, between two separate packaging methods (loose placement or placement of the products in an ordered manner in the packaging boxes), it allows a decrease in discards that may result from poor positioning in the packaging containers.

Lastly, by optimizing the volumes occupied by the products in the packaging containers and, in particular, by reducing empty volumes therein, it creates savings in terms of handing, logistics, and transport.

The invention cannot, however, be limited to the means and embodiments described or illustrated in this document, and extends in particular to all equivalent means and all technically operative combinations of such means. It should in particular be noted that the notions of products placed in bulk or in an ordered manner are interchangeable. This means that certain products, in particular long products (e.g. baguettes), can be packaged via the normally provided routing, through the sorting comb, for products to be placed in bulk in the packaging containers, whereas these products, due to their shape, will be organized naturally in a relatively ordered manner in these containers. This is in particular the case when large instantaneous quantities of such products are to be packaged: in this case, the robotic grasping means will be used to extract, from the production belt, the products assigned an attribute of non-compliance with the predetermined quality criteria, and a suitable device (for example a hopper) will advantageously be placed downstream of the sorting comb to facilitate the organization of the products in the packaging containers.

Likewise, it should be noted that, for example in the case where a large number of products comes at a fast production rhythm, it can be considered, without harming the invention, to arrange several production belts in parallel, each associated with a visiometry station, a set of grasping robots, and a sorting comb, but with single box conveyers for each packaging mode (placed in bulk or in an ordered manner in the boxes).

1) An equipment for distributing discrete products made to pass through a visiometry station, characterized in that it includes means for automatically commanding, in particular from location information provided for each of them by said visiometry station, either on the one hand the transportation of products to be placed in bulk towards a sorting comb through which said products are distributed by lots, or, on the other hand, the individual grasping of products using robot means commanded to transfer them laterally out of the transport line leading to said sorting comb and placing them in containers in an ordered manner.

2) The equipment according to claim 1, wherein it includes a means for alternately controlling the sorting comb from location information and count information collected in the visiometry station so as to allow some of the products to pass while potentially retaining certain others so as to form lots of predefined quantities of these products downstream said comb.

3) The equipment according to claim 1, wherein the robot means includes individual robotic grasping means distributed along (preferably on either side of) a production belt of the products, upstream of said sorting comb in the direction of advancement of said belt.

4) The equipment according to claim 1, wherein it includes a means for validating the grasping of products for transfer via said robotized means, which are automatically commanded to ensure that the number of products extracted from the production line for placement in each of the containers of products in an ordered manner is in compliance with predefined quantities.

5) The equipment according to claim 1, wherein it includes secondary visiometry control means via cameras associated with the robotic grasping and transfer means, whereof the field of vision is oriented to observe the lower surface of the products grasped by said robotic means during their transfer laterally outside the main production line towards the sorting comb, as well as a means for automatically processing the acquired images to deduce information therefrom on the presence of the grasped products validating the number of products whereof grasping was ordered for placement of predetermined quantities in said packaging containers for orderly products.

6) The equipment according to claim 4, wherein said validating means works by checking the weight of the grasped products.

7) The equipment according to claim 1, wherein it includes a means for comparing the quality and/or counting information collected in the visiometry station to a set of predefined quality criteria and for deducing, from this comparison, a compliance or non-compliance attribute with these criteria assigned to each of the passing products, and wherein it also includes a conveyor belt situated at the end of the input belt in the direction of advancement thereof, as well as means to, alternatively, on the one hand, order the advancement of said lateral conveyor belt in a normal operating direction to route products assigned a compliance attribute relative to said criteria and intended to be in bulk placed in said containers towards packaging containers circulating on a container conveyer, and, on the other hand, to command said conveyor belt to move in the opposite direction to route products assigned a non-compliance attribute towards ejection conveyors and reject zones when the products are to be placed in an ordered manner in packaging containers.

8) The equipment according to claim 1, wherein it comprises:
a main conveyor belt by which the products to be placed in the packaging containers are made to pass through a visiometry station in which information is collected in particular relative to their location, count, and/or quality, combined with a means for automatically processing this information,
a set of robot grasping and transfer means distributed along said main belt and associated with steering means to, on the one hand, when the products are to be placed in bulk in packaging containers, command the grasping of those of said products that, by control at the visiometry station, proved non-compliant with a set of predefined quality criteria, as well as their transfer on ejection conveyors arranged on either side of the main belt so they can be routed towards reject zones and, on the other hand, so as, once the products are placed in an ordered manner in the packaging containers, to automatically command the grasping of those of said products that, upon checking in the visiometry control station, were proved compliant with said predefined quality criteria, as well as their transfer into packaging containers passing on a conveyor nearby said robotic means,
a sorting comb placed downstream of said robotic means in the direction of advancement of the belt and the associated steering means so as, when the products are to be placed in bulk in the packaging containers, to group them together by lots of predetermined quantities so they can be routed through said comb towards a lateral conveyor belt commanded to pass at the end of the main belt in a first direction to route said products towards said packaging containers, and, on the other hand, when the products are to be placed in an ordered manner in the packaging containers, to route those of said products that, during their passage in the visiometry station, were proved non-compliant with said predefined quality criteria, towards said lateral conveyor belt, then commanded to move in a second direction to route these products towards said ejection conveyors and said reject zones.

9) A process for distributing discrete products passing through a visiometry station in which, for each product, information is collected relative to the location as well as the quality and/or count thereof, wherein said location information is used in combination with quality and/or count information in order ensure transportation of products intended to be placed in bulk in packaging containers towards a sorting comb through which they are grouped together in batches, or to command robot grasping and transfer means operating upstream of said to grasp products intended to be placed individually in packaging containers and to transfer them laterally out of the main transport line of the products towards the comb.

10) The process according to claim 9,
wherein quality information is collected in said visiometry station and compared to a set of predefined criteria in order to deduce therefrom a compliance or non-compliance attribute with said criteria,
and in that:
when the products are to be placed in bulk in the packaging containers, those of said products that are deemed compliant with said quality criteria are individually grasped by said robotic grasping means to be placed by lots in said packaging containers, whereas those of said products proved non-compliant with said quality criteria are made to continue their advancement without being retained by the sorting comb to be routed towards a reject zone,
when the products are to be placed in bulk in packaging containers, those of said products proved compliant with said quality criteria are routed towards said sorting comb, where they are grouped together by lots, then directed towards said containers, while those of said products proved non-compliant with said sorting criteria are individually grasped by said robotic means and transferred by the latter towards a reject zone.

11) The process according to claim 9, wherein, when the products of a lot of products are to be placed in bulk in packaging containers and the percentage of those of said products that, during their passage in the visiometry station, are assigned a non-compliance attribute with a set of predefined quality criteria, reaches a predetermined threshold, the products of said lot are routed entirely towards a reject zone.

12) The process according to claim 9, wherein, when the products are to be placed in an ordered manner in the packaging containers, a validation of the grasping of said products is done in particular from information relative to their weight collected at the robotic grasping means or from images of their lower surfaces collected by cameras placed between said robotic means and the main production line of said products.
